(19) United States
(12) Patent Application Publication
(10) Pub. No.: US 2015/0305371 A1
(43) Pub. Date: Oct. 29, 2015

(54) Stable Food Coating

(71) Applicant: The IAMs Company, Cincinnati, OH (US)

(72) Inventor: Maria Dolores Martinez-Serna Villagran, Mason, OH (US)

(21) Appl. No.: 14/260,257

(22) Filed: Apr. 23, 2014

(51) Int. Cl. A23K 1/00

(52) U.S. Cl. CPC A23K 1/004

(57) ABSTRACT

Formulations and methods for managing variable fat mobility when foods are exposed to temperature cycling, as during transportation and storage. Stability of the fat within the food may be influenced by, for example, using primarily non-polymorphic fats, limiting the aqueous content of the fat, using dry additives in the fat (if additives are used), or modifying the food itself.

### FIELD OF THE INVENTION

This disclosure relates to an edible coating composition, particularly an edible coating composition for pet food.

### BACKGROUND OF THE INVENTION

Processed foods may be coated for flavor, texture, mouth feel, or other reasons. Savory foods, as well as pet foods, may have a coating that contains fat. Fat may contribute flavor and smooth mouth feel. However, in some instances fat may present an oily or sticky texture that can be undesirable. An oily or sticky texture may provide an undesirable organoleptic experience, or may make the product unappealing to handle or consumer. For example, food that leaves greasy or oily marks, smears, or smudges either on the food packaging, hands, or serving bowls or utensils, may be unappetizing, or may be excessively messy. In some instances, a product using the same ingredients in the same proportions may present a pleasant texture on some occasions and an unappealing texture on other occasions.

There remains a need for a predictable, consistently pleasant fat coating for processed foods.

### SUMMARY OF THE INVENTION

In some aspects, the invention relates to a coating composition. The coating composition may comprise a polymorphic fat. The polymorphic fat may comprise no more than 20% of the polymorphic and non-polymorphic fat in the coating composition. The polymorphic fat may be derived from pork. The non-polymorphic fat may be predominantly derived from poultry. The non-polymorphic fat may be predominantly derived from chicken. The coating composition may be substantially free of aqueous liquids. The coating composition may comprise up to 5% dry palatants.

In some aspects, the invention relates to a coated food product. The coated food product may comprise a gelatinized starch matrix. The food product may have a bulk density no greater than 420 g/L. The food product may be coated with a coating composition comprising a polymorphic fat. The polymorphic fat may comprise no more than 20% of the polymorphic and non-polymorphic fat in the coating composition. The non-polymorphic fat may be predominantly derived from poultry. The non-polymorphic fat may be predominantly derived from chicken. The coating composition may be substantially free of aqueous liquids. The coating composition may comprise up to 5% dry palatants. The food product may be a pet food. The pet food may be nutritionally balanced. The total fat content of the pet food may be less than or equal to 20% by weight of the food. The coating may contribute less than or equal to 10% fat by weight of the food.

### BRIEF DESCRIPTION OF THE DRAWINGS

FIG. 1 is a schematic representation of an exemplary coated food product.

### DETAILED DESCRIPTION OF THE INVENTION

As used herein, “predominantly” means more than 75% of a sub-type of ingredient, by weight of that type of ingredient. For example, a mixture of fats derived predominantly from poultry would more than 75% poultry fat, by weight of the mixture of fats, with the remainder of the fat from some other source (e.g., beef, pork, vegetables, grains, fruits, seafood, fish, dairy products, eggs, etc.).

As used herein, “substantially free of” means containing no more than 2% of, by weight. A composition substantially free of a particular substance may have “no added” amount of that substance, which is to say that no amount of that substance is added intentionally, although there may be trace amounts of that substance present from other sources. For example, a composition may have no added artificial colors, but still contain some artificial colors if the artificial colors are a component of another ingredient.

As used herein, “dry” refers to ingredients having a water content of less than 50% by weight of the ingredient as-used. Some dry ingredients may have a water content of less than 35% by weight of the ingredient as-used, or less than 20% by weight of the ingredient as-used.

As used herein, “nutritionally balanced” refers to a composition formulated and intended to be the sole ration for an animal other than a human. A nutritionally balanced composition is capable of maintaining life without any additional substances being consumed, except possibly water. Generally accepted nutritional needs are described, for example, in Nutrient Profiles for dogs and cats published by the Association of American Feed Control Officials (AAFCO).

As used herein, “companion animals” or “pets” means dogs, cats, and/or other domesticated animals of like nutritional needs to a dog or a cat. For example, other domesticated animals of like nutritional needs to a cat may include minks and ferrets, who can survive indefinitely and healthily on a nutritional composition designed to meet the nutritional needs of cats. It will be appreciated by one of skill in the art that dogs and cats have nutritional needs which differ in key aspects. At a fundamental level, dogs are omnivores, whereas cats are obligate carnivores. Further, nutritional needs are not necessarily consistent with phylogenetic or other non-nutritional classifications. A nutritionally balanced pet food may be for a dog, including puppies (up to 1 year of age), adults (over 1 and less than 7 years of age), seniors (from 7-10 years of age), and/or super-seniors (over 10 years over age). A nutritionally balanced pet food may be for a cat, including kittens (up to 1 year of age), adults (over 1 and less than 7 years of age), seniors (from 7-10 years of age), and/or super-seniors (over 10 years over age). A nutritionally balanced pet food may be for a ferret, including kits (up to 6 months of age), adults (6 months of age or older), and/or seniors (4 years of age or older).

Unless otherwise specified, “carbohydrate” is measured as nitrogen-free extract (NFE), consisting of carbohydrates, sugars, starches, and a major portion of materials classified as hemicellulose (if present). When crude protein, fat, water, ash, and fiber are added and the sum is subtracted from 100, the difference is NFE.

Processed foods, particularly, but not exclusively, processed foods that are intended to be shelf-stable without refrigeration for 6 months or more, may have a low water content to prevent undesirable microbial growth in the food overtime. Low water content, however, may be associated with undesirably dry, powdery, or hard textures when the processed food is eaten. For many processed foods, additional fat is added to improve mouth feel and the perception of moistness without increasing the water content or water activity level of the food. Fat may be a favored additive for this purpose because it may also add a pleasant flavor.

Some processed foods, in particular those having a gelatinized starch matrix, contain relatively little internal fat due to processing constraints. Commonly used preparation processes, such as extrusion cooking, may be slowed or complicated by adding fat to the food as it is formed. Instead of increasing the fat in the food as it is prepared, a fat coating may be applied to the exterior of a food product. This both avoids possible process complications, and makes the fat more available to the mouth during consumption. However, fat coatings may occasionally exhibit undesirable textures, such as oiliness or greasiness, or a sticky feel. In some cases, these undesirable textures may present only intermittently, with some products presenting a pleasant texture, and some products of the same formula presenting oiliness, and some products of the same formula presenting stickiness. Different textures may arise intermittently, making it difficult to pinpoint the factors that contribute to one texture or another.

It has been found that the texture differences may be driven by polymorphism. Polymorphism refers to the availability of different macrostructural crystalline forms for the same molecule or substance. With fats, different polymorphs may form, for example, under different temperature conditions, or in the presence of other substances in the crystal form (e.g., water, particulates, or other substances). Fats may occur in three main crystalline arrangements, namely α, β′, and β, in order of increasing stability and melting point. The α polymorph is the least stable and has the lowest melting point. The β polymorph is most stable and has the highest melting point. The β′ polymorph has intermediate properties between those of the α and β forms. Crystalline forms are understood to be related to melting temperature and oxidative stability.

Pork fat often has a β′ crystal structure, so during melting, the crystals can melt and resolidify in a more stable crystalline arrangement. Typically, crystalline form is initially influenced by controlling processing conditions for the fat. Factors such as the temperature of the fat when applied (usually in a heated, liquid state) and the time and temperature conditions as the fat cools (often to a room temperature, solid state) are known to influence morphology. However, if the fat is exposed to temperature extremes after manufacturing, e.g., during distribution, or storage before or after purchase by the ultimate consumer, melting and/or freezing cycles can modify the crystal morphology relative to the morphology present during food processing. Therefore, it is necessary to consider means to influence the morphology of the fat during temperature changes after initial processing, when temperature may be uncontrolled. Depending on the season and the distribution and shipping channels for a particular product, it is possible for a product to see temperature variations of 70° C. or more, e.g., from freezing conditions in a cargo hold during bulk shipment to extremely hot conditions in the trunk of a car in the summer after purchase by a consumer, or vice versa. In some instances, particularly for processed foods with geographically extensive distribution chains or long shelf lives, a processed food may experience two or more cycles of heating and freezing prior to consumption.

Fat morphology may be influenced by the type of fat used, total fat content of the food, the amount of fat applied on the exterior of the food, the bulk density of the food, additives (other substances) within the fat coating on the exterior of the food, and other ingredients in the food itself. There may further be interactions between these factors and the rate of fat cooling during food processing.

### Types of Fats

Different fat sources may be more or less prone to polymorphism. For example, poultry fats, particularly chicken fat with low water content, may be largely stable after initial crystallization, in that it tends to exhibit a single melting point. One of skill in the art will appreciate that the actual melting temperature of the fat will depend on the source and purity of the fat, as well as the nature of any impurities in the fat (e.g., water, protein, minerals, palatants, antioxidants, or others). These stable crystalline arrangements may be prone to non-polymorphic melting characteristics. In contrast, pork fat may be inclined to polymorphism, in that it may tend to exhibit two or more melting points. It should be noted that the number of melting points within a given temperature range is not necessarily correlated to the oxidative stability of the fat or the value of a particular melting point (e.g., the melting point, or the lowest melting point for fats exhibiting more than one melting point).

In some aspects, the invention relates to a processed food. The processed food may be coated with a coating composition that is predominantly composed of fat. The fat may comprise polymorphic fat (e.g., a fat or mixture of fats having two or more melt points between 30 and 50° C. at 1 atm) and/or non-polymorphic fat (e.g., a fat or mixture of fats having a single melt point or no melt point at temperatures between 30 and 50° C. at 1 atm). Exemplary fats which tend to be polymorphic include fat derived from pork, palm oil, coconut oil, and combinations thereof. Exemplary fats which tend to be non-polymorphic include fat derived from poultry, such as chicken fat, canola oil, and combinations thereof. The coating composition may comprise polymorphic fat and non-polymorphic fat. The coating composition may comprise greater than 0% and no more than 20% polymorphic fats, by weight of the coating composition.

### Fat Content of the Food

The total fat content of the food may influence how readily the fat re-crystallizes on the surface of the product and/or may influence the severity or perceived severity of undesirable texture changes associated with fat polymorphism. In some aspects, the invention relates to a product having a total fat content (including “internal” fat included in the base formula for the food and any “external” fat applied as a separate coating) of less than 25%, or less than 20%, or less than 15% by weight of the food.

Externally applied fat may be more likely to cause undesirable textures upon melting and resolidifying. Reducing the amount of fat applied externally does not change the tendency of the fat to polymorphism, but may influence the severity or perceived severity of undesirable texture changes associated with fat polymorphism. In some aspects, the invention relates to a product having a total external fat content of less than 15%, or less than 10%, or less than 7%, or less than 5%, externally applied fat by weight of the food.

### Bulk Density of the Food

The bulk density of the food may influence the exchange of internal and external fats, and may, therefore, be particularly relevant to oiliness or greasiness. In some aspects, the invention relates to a food having a bulk density of less than 520 g/L, or less than 500 g/L, or less than 450 g/L, or less than 420 g/L, or less than 400 g/L. A lower bulk density may provide more capacity for the food to absorb fat that has been melted, rather than transferring the fat, e.g., to the interior surface of the packaging for the food. In some instances, visual or tactile perception of smudges of fat on the interior of the packaging may negatively influence consumer perception of how appetizing a food is even if the texture of the food itself would otherwise be acceptable. In some instances, packaging may wick fat from the interior of the package to the exterior of the package, potentially creating visibly or tactilely perceptible greasy spots that may deter purchase of the food product, even if the texture of the food itself would otherwise be acceptable.

### Fat Additives

In some instances, fat is supplemented with additives prior to being added to a food. For example, antioxidants, such as tocopherols, are frequently added to fats of many types to preserve fat oxidation during storage and handling. External fats, in particular, but not exclusively, may be supplemented with flavors or other additives to enhance the organoleptic experience when the food is consumed. Such additives may include, for example, salts, sugars, amino acids, chemical or enzymatic animal tissue digests, and combinations thereof. Many of these additives are available in dry forms (e.g., powders produced as by thermal drying or freeze drying) and aqueous compositions. In either form, additives may influence the crystalline structure of an external fat coating and/or the susceptibility of an external fat coating to transition to an alternate morphology. In some aspects, the invention relates to a fat-based coating composition containing less than 20% additives (including moisture), or less than 15% additives, or less than 10% additives. In some aspects, the invention relates to a fat-based coating composition containing only dry additives, or containing at least 95% dry additives by weight of the additives, or containing at least 90% dry additives by weight of the additives. In some aspects, the invention relates to a fat-based coating composition comprising an animal organ tissue digest. The coating composition may comprise less than 5% animal tissue digest, or less than 3% animal tissue digest, by weight of the coating composition. In some aspects, the coating composition is substantially free of aqueous liquids.

### Non-Fat Ingredients

Non-fat ingredients in the base food composition (as compared to any fat-based ingredients or external coatings) may also influence the texture or perceived texture of fats in or on the food. Although the mechanism is not fully understood, relatively high protein content may be associated with lower product porosity. If a fat in a β or β′ structure separates into distinct crystalline forms, observable as 2 or more peaks measurable using Differential Scanning calorimetry or DSC, the lower product porosity may allow the fat to migrate from the interior of the food to the exterior of the food on exposure to temperatures at or above the melting temperature of the polymorphic fat (in its original crystalline state following processing). This may result in a sticky exterior, which may provide an unpleasant tactile sensation when handling the food, or may result in food particles sticking together, providing an unattractive clump of food that is difficult to serve or eat. In some aspects, the invention relates to a food product having a protein content of less than 50%, or less than 40%, or less than 30%, or less than 25%, by weight of the total food (including all fats and coatings).

Relatively high carbohydrate content may be associated with a tendency for polymorphic fat, when exposed to temperatures at or above the melting temperature of the polymorphic fat (in any crystalline state, at any time following processing) to migrate from the food to packaging or other substances (e.g., as the food is dispensed out of the package), giving the impression of an oily, greasy product. In some aspects, the invention relates to a food product having a carbohydrate content that is less than 70%, or less than 40%, or less than 25%, by weight of the total food (including all fats and coatings).

Relatively low grain content may be associated with a tendency for polymorphic fat, when exposed to temperatures at or above the melting temperature of the polymorphic fat (in any crystalline state, at any time following processing) to migrate from the food to packaging or other substances (e.g., as the food is dispensed out of the package), giving the impression of an oily, greasy product. Traditionally, grains such as wheat and corn have been central ingredients to many extrusion-cooked, puff-type foods, including breakfast cereals and dry pet foods. However, some recent food trends have touted alleged health benefits associated with reducing the intake of gluten and/or grains. As a result, there is sometimes demand for products having reduced grain content. In some aspects, the invention relates to a food product having a grain content between 50% and 40%, or 30% and 20%, or any range therebetween, by weight of the total food (including all fats and coatings). In some aspects, the invention relates to a food product comprising grains selected from corn, wheat, quinoa, amaranth, rice, barley, sorghum, and combinations thereof.

If desired, maltodextrin may be added to a fat-based coating solution. Although the mechanism is not understood, maltodextrin may reduce the likelihood of oily texture when using externally applied polymorphic fat. Maltodextrin may be useful for this purpose at 2% to 12%, or 2% to 6% by weight of the fat-based coating composition. The addition of maltodextrin may be particularly useful in the presence of other conditions which tend to contribute to an oily texture, such as a carbohydrate content greater than 20%, a grain content less than 25%, an externally applied fat-based coating composition comprising more than 20% polymorphic fat, by weight of the fat in the coating composition, or combinations thereof.

### Food Product

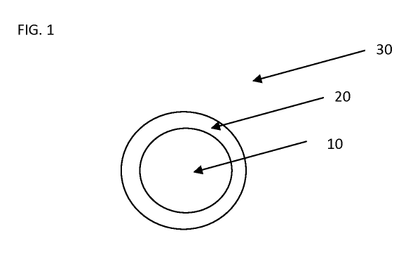

In some aspects, the invention relates to a coated food product. FIG. 1 illustrates schematically a cross-sectional view of a coated food product 30 having a food base 10 and an external coating 20. It should be appreciated that the food base 10 is shown as circular for simplicity, but could have any desirable cross-section or size. Similarly, external coating 20 is shown as largely uniform around the entire exterior of food base 10, but external coating 20 need not be complete, uniform, symmetrical, or shaped like food base 10. In some embodiments, external coating 20 may be applied on only one surface, side, or face of a food base, or on less than all surfaces, sides, or faces of a food base. In some instances, external coating 20 may itself comprise one or more sub-layers of coatings, which may be compositionally or structurally distinct.

The food product may be coated with a fat-based coating composition (stated differently, a coating composition that comprises predominantly fats). The food product may have a gelatinized starch matrix. The food product may be extrusion cooked. The food product may be in a low-density “puff” form, like some breakfast cereals and dry pet foods. The food product may be processed, meaning that the food has been modified from naturally available foods beyond harvesting, cleaning, and packaging. Exemplary food products include breakfast cereals, dry pet food, bars (including breakfast, snack, meal-replacement, and energy bars), crackers, and cookies.

If the food is a pet food, the food may have a moisture content of less than 15%, or less than 10%, or even less than 5%. The food may be complete and nutritionally balanced. The food may be for a companion animal. The food may be for a companion animal of any life stage, including puppies, kittens, kits, adults, seniors, or super-seniors. The food may be a treat or supplement. The food may be substantially free of grains, within the meaning of the AAFCO animal feed definitions.

### EXAMPLES

Three coated food products were prepared and evaluated for response to possible environmental conditions. A pet food kibble base food was prepared to meet AAFCO guidelines for a nutritionally balanced dog food, less total fat content (as some fat would typically be contributed by a fat-containing external coating). For each sample, 100 g of the same base food was used. A fat-based coating was prepared and applied to each kibble sample at a rate of 4% coating composition by weight of the total/coated food weight as follows:

| Sample | A | B | C |
|---|---|---|---|
| Composition | 100% chicken | 80% chicken | 50% chicken |
| | fat | fat:20% pork fat | fat:50% pork fat |
| Palatant | None | Liquid, 3% of | Dry, 2% of |
| | | coating composition | coating composition |

| | | |
|---|---|---|
| Conditions | Exposure | Cycled Exposure from 50° C. |
| | 50° C. | to 5° C. to 50° C. |

After temperature condition exposure, hexane extraction was used to assess the amount of fat on the outside of the kibble. All samples showed an increase in external fat content after temperature cycling, with the increase in external fat content correlating positively to the percentage of pork fat in the composition. External fat content was measured by hexane extraction, as described below. Separately, similar samples were qualitatively assessed for stickiness, and a correlation was observed between stickiness and external fat content.

### Hexane Extraction

Weigh 10 g of sample into a beaker. In a fume hood, add 25 mL of hexane to the beaker containing the sample. Gently swirl the beaker and allow it to stand for 15 minutes. Pour the liquid extract into another beaker of known mass, leaving behind the solid sample remnants in the first beaker. Remove the hexane by evaporation at room temperature. Determine the amount of reside (fat) by reweighing the second beaker.

### Qualitative Stickiness Testing

Put 10 kibbles (control or temperature-treated) on a clean laboratory surface. Press the palm of a bare hand firmly on the kibbles for 5 seconds. Lift hand from surface and count the number of kibbles stuck to the hand.

### Bulk Density

Clean and level a calibrated scale with 1-gram or better resolution. Tare the scale using a clean, dry, calibrated 1-Liter cup. Position a funnel having a minimum diameter sufficient to allow the kibble to be tested to flow freely, and a maximum diameter at the same point to channel kibble into the 1-L cup or vessel, approximately 2 inches above the top of the 1-L cup with the bottom (outlet) of the funnel blocked. Gently fill the funnel with slightly more than 1-L of kibble to be tested. With the 1-L cup under the funnel, unblock the funnel and allow the kibble to flow into the 1-L cup. Using a straight-edge (such as a ruler or strike stick), remove excess kibble by sliding the straight-edge smoothly across the top of the 1-L cup. The kibble should not be level with the rim of the 1-L cup. Place the 1-L cup on the tared scale and record the results. The bulk density is the scale reading (in grams) divided by 1-L.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A coating composition comprising polymorphic fat at no more than 20% of polymorphic and non-polymorphic fat in the coating composition.

2. The coating composition of claim 1, wherein the polymorphic fat is derived from pork.

3. The coating composition of claim 1, wherein the non-polymorphic fat is predominantly derived from poultry.

4. The coating composition of claim 3, wherein the non-polymorphic fat is predominantly derived from chicken.

5. The coating composition of claim 1, wherein the coating composition is substantially free of aqueous liquids.

6. The coating composition of claim 5, wherein the coating composition comprises up to 5% dry palatants.

7. A coated food product comprising a gelatinized starch matrix, wherein the food product has a bulk density no greater than 420 g/L and is coated with a composition according to claim 1.

8. The coated food product of claim 7, wherein the polymorphic fat is derived from pork.

9. The coated food product of claim 7, wherein the non-polymorphic fat is predominantly derived from poultry.

10. The coated food product of claim 9, wherein the non-polymorphic fat is predominantly derived from chicken.

11. The coated food product of claim 7, wherein the coating composition is substantially free of aqueous liquids.

12. The coated food product of claim 11, wherein the coating composition comprises up to 5% dry palatants.

13. The coated food product of claim 7, wherein the food product is a pet food.

14. The coated food product of claim 13, wherein the pet food is nutritionally balanced.

15. The coated food product of claim 13, wherein the total fat content of the pet food is less than or equal to 20% by weight of the food.

16. The coated food product of claim 15, wherein the coating contributes less than or equal to 10% fat by weight of the food.
